(19) United States
(12) Patent Application Publication
(10) Pub. No.: US 2016/0018843 A1
(43) Pub. Date: Jan. 21, 2016

(54) FORCE FEEDBACK MINI-SHAFT FOR ELECTROMAGNETIC CONTROL

(71) Applicant: MIDI INGENIERIE, Toulouse (FR)

(72) Inventor: BenoîT LOPEZ, Cessalles (FR)

(73) Assignee: MIDI INGENIERIE, Toulouse (FR)

(21) Appl. No.: 14/765,668

(22) PCT Filed: Feb. 5, 2014
(86) PCT No.: PCT/EP2014/052255

§ 371 Date: Aug. 4, 2015

(30) Foreign Application Priority Data
Feb. 5, 2013 (FR) 13 00235

(51) Int. Cl. G05G 5/03; G05G 1/04

(52) U.S. Cl. CPC G05G 5/03; G05G 1/04

(57) ABSTRACT

The invention relates to a mini-shaft that comprises: a joystick (2); a hinge part (4) having a first portion (8) having a first magnetic polarity, and a second portion (10) having a second magnetic polarity; a connection between the hinge part (4) and the joystick (2); a first part (12) arranged opposite the first portion (8); a second part (14) arranged opposite the second portion (10); first polarization means (18) enabling the parts (12, 14) to be controlled; sensors of the position of the joystick (2); and control means which perform control on the basis of the measurement signals from the sensors and of a predetermined force feedback rule.

### FIELD OF THE INVENTION

The present invention concerns an electromechanical side-stick with force feedback.

### BACKGROUND

One field of application of the present invention is the production of side-sticks for controlling aircraft, such a fixed-wing aircraft or a helicopter, for example. In the aeronautical field, an aircraft is a flying machine having supporting means and propulsion means enabling it to move. To control an aircraft, control means are provided and act on mobile elements known as control surfaces. When the aircraft is flying, it is able to pivot about three axes referred to as the pitch axis, the roll axis and the yaw axis through action on the corresponding control surfaces provided for this purpose.

A control column is a device enabling an aircraft pilot to control the attitude of the aircraft with respect to its pitch and roll axes. These actions then enable inclination of the machine on turning or changing altitude.

A system of cables conventionally provides a connection between the control column and the control surfaces and, by maneuvering the control column, a pilot transmits forces directly to the control surfaces. This system is still used on “light” fixed-wing aircraft. On heavier fixed-wing aircraft, hydraulic devices make it possible to assist the pilot. Finally, on recent fixed-wing aircraft, it is routine for the control surfaces to be connected to electrical actuators and for the control column therefore no longer to transmit any physical force. In this case, the control column is usually of small size and is then referred to as a side-stick. Hereinafter, the expression control column refers equally to a “classic” control column which extends from the floor (of a cockpit) to within hand's reach of a pilot seated on a pilot's seat and a side-stick taking the form of a joystick that can be placed at various locations in an aircraft cockpit within hand's reach of a pilot, of course. Moreover, the term pilot designates equally the pilot of an aircraft (fixed-wing aircraft, helicopter or other aircraft) and a copilot, if any.

In a modern aircraft the connection between the control column and the control surface of the aircraft is therefore provided by a transmission system associated with electronic control means and supplying the necessary forces, for example by controlling electrical actuators, to cause the control surfaces to assume the orientation corresponding to the position of the control column. As there is no direct interaction between the control column and the control surfaces, the latter are unable to return a feedback force to the control column.

For a variable resistance to oppose movement of the control column by the pilot, it is known to provide the control column with a force feedback device simulating a feedback force of the control surfaces on a “classic” control column. A side-stick usually includes a joystick guided by a system of universal joints and links associated with various sensors and notably position sensors. The force feedback is often produced by simple springs. This solution does not make it possible to control the feedback force. It is also known to use reducers or linear type actuators. Problems of reversibility then arise, however.

The document DE-195 01 439 discloses an electromechanical device including a mobile part, or rotor, on which a torque produced electromagnetically can be exerted. This torque is transmitted without contact and with no mechanical coupling to the rotor. The stator includes a yoke with a base and lateral parts together with pole pieces including a slot defining two teeth. The rotor takes the form of a magnetized ring or cylinder disposed between an upper pole piece and a lower pole piece as well as an actuating joystick. The rotor is mounted on a bearing allowing it two or three degrees of freedom. A current flowing in coils associated with the lateral parts produces a magnetic field that is asymmetrical when the joystick is not at rest and therefore creates a return torque by a reluctance effect.

For its part, document WO-00/03319 discloses a system for controlling a cursor on a computer screen or the like using a pointing device of a type known in itself. This pointing device comprises an indicator device offering tactile feedback to the user in order to transmit information on the movements of the cursors on the screen. This indicator device is designed to transmit information in at least two dimensions. Here the system uses an operating principle very close to that described in the document DE-195 01 439 but not including an actuating joystick.

These prior art devices enable the creation of a torque by causing the reluctance to vary in an electromechanical system. The torque created is a return torque to a reference position. There is no provision here for acting on the system to move it to a position other than this reference position.

An object of the present invention is therefore to provide a side-stick including a force feedback system for exerting on the joystick of a side-stick a force representing a feedback force from the control surfaces. The force feedback is therefore not necessarily controlled by a rule depending only on the position of the side-stick but also able to involve other parameters. The system provided by the invention will advantageously make it possible to position the side-stick in various positions without mechanical action on the latter.

### SUMMARY

The proposed device will advantageously be compact and preferably more compact than existing systems so as to obtain a side-stick that is less bulky than known side-sticks.

The present invention firstly proposes a side-stick with force feedback including a joystick having a degree of freedom in rotation about a first articulation axis.

In accordance with the present invention, such a side-stick includes:
a first articulation part including a first portion having a first magnetic polarity and a second portion having a second magnetic polarity opposite the first magnetic polarity,
reversible movement transmission means between the first articulation part and the joystick connecting the first articulation part to said joystick so that a movement of rotation of the joystick about the first articulation axis is transmitted to the first articulation part which can additionally drive the joystick in rotation about its first articulation axis,
at least one first pole piece essentially (or exclusively) facing the first portion of the first articulation part,
at least one other, second pole piece essentially (or exclusively) facing the second portion of the first articulation part,
first polarization means for acting on the first pole piece to polarize it with the first magnetic polarity,
second polarization means for acting on the second pole piece to polarize it with the second magnetic polarity,
means supplying measurement signals representing the position and/or the movement of the joystick or of the articulation part, and
control means acting on the first polarization means and on the second polarization means in such as manner as to vary the magnetic field created by the first polarization means and the magnetic field created by the second polarization means as a function of the position and/or movement measurement signals and optionally as a function of a predetermined force feedback rule.

This novel structure for a side-stick proposes to place the control joystick on magnetic bearings and to act on magnetic fields in the air gaps to control a feedback torque (or feedback forces) on the joystick. It is equally possible with such a structure to act on the joystick to move it exclusively by controlling the polarization means.

There must be understood by the expression transmission means as much a direct connection (by screwing, gluing, etc.) in which the joystick and the articulation part are fastened to each other as a connection involving intermediate parts mobile relative to the joystick and/or the articulation part.

The term “essentially” is used to signify that each pole piece faces a single portion of the articulation part and that there is no provision for it to come to face the other portion of the articulation part. It may optionally project from the portion of the articulation part that it faces, notably as a function of the position of that articulation part, but such projection remains marginal. The aim here is to place face-to-face on the one hand a pole piece with a magnetic polarity imposed by the polarization means and on the other hand a portion of the articulation part with a single polarity (and not face-to-face with two different polarities as in the prior art).

Each pole piece may advantageously face only a portion of the articulation part in a position that might be referred to as a neutral position or rest position. The pole pieces may also be such that in all positions of the articulation part each pole piece faces only one portion of the articulation part.

The joystick is most often controlled with the aim of producing force feedback and a predetermined force feedback rule is used to control the device. However, in the case of automatic control of the position of the joystick, with no action by an operator, a control rule other than the force feedback rule referred to will be used to control the joystick.

The structure proposed hereinabove concerns a side-stick including a joystick with one degree of freedom. This structure may also be adapted to suit a side-stick in which the joystick has a second degree of freedom about a second articulation axis. Such a side-stick then further includes, for example:
a second articulation part including a third portion having a first magnetic polarity and a fourth portion having a second magnetic polarity opposite the first magnetic polarity,
reversible movement transmission means between the second articulation part and the joystick connecting the second articulation part to said joystick so that a movement of rotation of the joystick about the second articulation axis is transmitted to the second articulation part which can additionally drive the joystick in rotation about its second articulation axis,
at least one third pole piece essentially (or exclusively) facing the third portion of the second articulation part,
at least one other, fourth pole piece essentially (or exclusively) facing the fourth portion of the second articulation part,
third polarization means for acting on the third pole piece to polarize it with the first magnetic polarity, and
fourth polarization means for acting on the fourth pole piece to polarize it with the second magnetic polarity.

This structure is a combination of two structures suitable for a joystick with one degree of freedom.

Based on the same inventive principle as before, the present invention proposes a side-stick with force feedback including a joystick having a first degree of freedom in rotation about a first articulation axis and a second degree of freedom in rotation about a second articulation axis.

This side-stick includes:
an articulation part including a first portion having a first magnetic polarity and a second portion having a second magnetic polarity opposite the first magnetic polarity,
reversible movement transmission means between the first articulation part and the joystick connecting said articulation part to said joystick so that a movement of rotation of the joystick about the first articulation axis and about the second articulation axis is transmitted to the articulation part which can additionally drive the joystick in rotation about the first articulation axis and about the second articulation axis,
at least a first pole piece and a third pole piece essentially (or exclusively) facing the first portion of the articulation part,
at least a second pole piece and a fourth pole piece essentially (or exclusively) facing the second portion of the articulation part,
first polarization means for acting on the first and third pole pieces to polarize them with the first magnetic polarity,
second polarization means for acting on the second and fourth pole pieces to polarize them with the second magnetic polarity,
means supplying measurement signals representing the position and/or the movement of the joystick or of the articulation part, and
control means acting on the first polarization means and on the second polarization means in such as manner as to vary the magnetic field created by the first polarization means and the magnetic field created by the second polarization means as a function of the position and/or movement measurement signals and optionally as a function of a predetermined force feedback rule.

Here, in accordance with the same principle, for a side-stick with a joystick with two degrees of freedom, the same articulation part is used for the two articulation axes.

In a side-stick in accordance with the present invention, whether it includes only one or a plurality of articulation parts, it is proposed that at least one articulation part, and preferably each articulation part, include a central magnet between two parts made from a magnetic material so that one part is polarized by the magnet with a first magnetic polarity and the other part is polarized by the magnet with a second magnetic polarity opposite the first magnetic polarity.

The polarization means used in a side-stick in accordance with the invention include, for example, a coil disposed around a magnetic material core and means for supplying the coil with electrical current.

To guarantee the polarization of each pole piece, even in the absence or failure of the polarization means, each pole piece is advantageously polarized by a magnet. A stable position of the side-stick can therefore be attained even in the absence of current.

In a side-stick in accordance with the present invention, in order to create air gap modifications when the articulation part is moved, each pole piece facing an articulation part portion advantageously has a surface facing the articulation part such that on rotation of the articulation part about an articulation axis the distance between a given point of said surface and the articulation part varies.

### BRIEF DESCRIPTION OF THE DRAWINGS

Details and advantages of the present invention will become more apparent from the following description given with reference to the appended diagrammatic drawings in which:

FIG. 1 shows diagrammatically in elevation a first embodiment of the present invention in which a side-stick includes a joystick with only one degree of freedom,

FIG. 2 is a view similar to that of FIG. 1 in which the joystick is in a different position,

FIG. 3 is a view to a larger scale of a detail of FIG. 2 showing the forces and torques involved,

FIG. 4 is a diagrammatic perspective view of a second embodiment of the present invention in which a side-stick includes a joystick with two degrees of freedom,

FIG. 5 shows a variant embodiment for the embodiments of the preceding figures,

FIG. 6 shows diagrammatically in perspective a third embodiment of the present invention,

FIG. 7 shows diagrammatically in perspective a fourth embodiment of the present invention,

FIG. 8a is a diagrammatic elevation view of a fifth embodiment of the invention,

FIG. 8b shows diagrammatically in perspective the fifth embodiment from FIG. 8a, and

FIG. 9 shows diagrammatically one example of an overall architecture of a side-stick in accordance with the present invention.

### DETAILED DESCRIPTION OF THE PREFERRED EMBODIMENTS

The present invention concerns a side-stick that can be used to control a fixed-wing aircraft or a helicopter. Other applications of the present invention may be envisaged, however, for example to a control system in a terrestrial or naval craft, for example, site plant, crane, ship, submarine, etc., for example.

A side-stick classically includes a casing (not shown in the drawing) inside which is located a mechanism associated with a joystick 2. In a novel manner, the mechanism includes magnetic bearings and/or a magnetic ball-joint as described hereinafter.

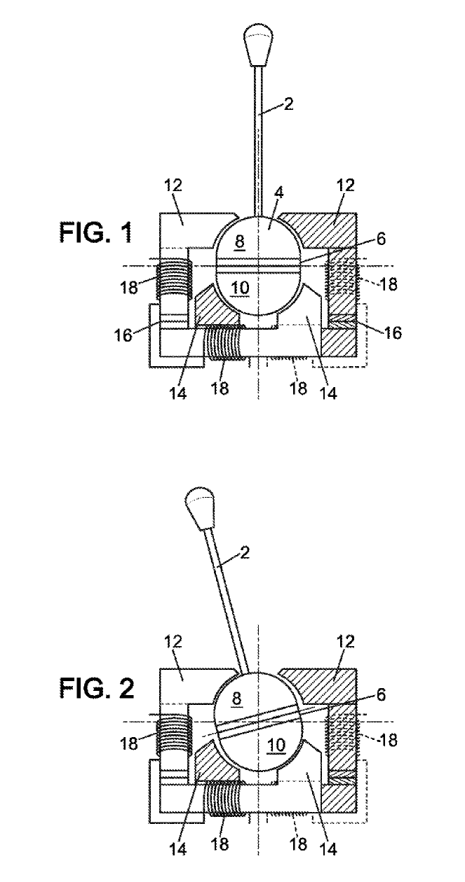

In an aeronautical application, the joystick 2 is most often mobile in rotation about two articulation axes. For a better understanding of the principle implemented by the present invention, FIGS. 1 to 3 concern only movement about only one articulation axis. A side-stick in which the joystick 2 moves with only one degree of freedom can be envisaged without departing from the scope of the present invention, although the present invention is more particularly suited to a side-stick with a joystick having two degrees of freedom.

In the first embodiment (FIGS. 1 to 3), the joystick 2 is associated with an articulation part that here takes the form a ball-joint 4 to which it is fixed. The ball-joint 4 is mounted on magnetic bearings defined by pole pieces described hereinafter.

The ball-joint 4 of FIGS. 1 to 3 is formed of a magnet 6 having a north pole and a south pole, a first half-sphere 8 and a second half-sphere 10.

The magnet 6 has the shape of a disc and is cut out from a magnetic material so that the north pole corresponds to one face of the disc and the south pole to the opposite face. Here each half-sphere has a diameter corresponding to the diameter of the magnet 6. A plane face of each half-sphere coincides with a face of the magnet 6. The magnet 6 is therefore sandwiched between the first half-sphere 8 and the second half-sphere 10. Each of these two half-spheres is made from a magnetic material so that they are both polarized. It will be assumed for example that the first half-sphere 8 corresponds to the north pole of the magnet 6 while the second half-sphere 10, with the magnetic polarity that is the opposite of the magnetic polarity of the first half-sphere 8, corresponds to the south pole of the magnet 6.

Here it is proposed to dispose the first half-sphere 8 facing two first pole pieces 12 polarized so as to correspond to a north pole and to dispose the second half-sphere 10 facing two second pole pieces 14 polarized so as to correspond to a south pole. In this way, the pole pieces exert a repulsion force on the ball-joint 4 and form magnetic bearings. Note that here each pole piece faces only one part of the ball-joint 4, i.e. one half-sphere, without facing the other part (half-sphere) of the ball-joint that is oppositely polarized.

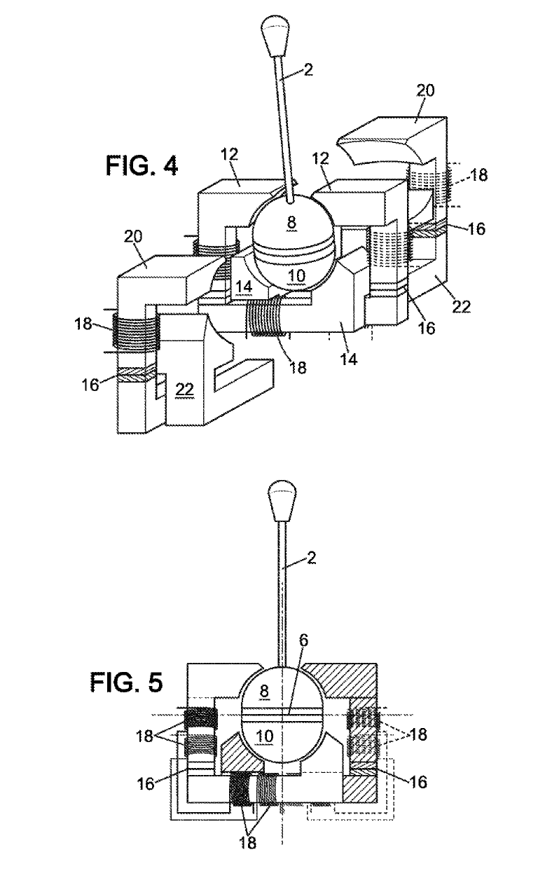

Thus two assemblies are formed around the ball-joint 4, each assembly including a first pole piece 12, a second pole piece 14 and a magnet 16. As shown in FIGS. 1 and 2, each assembly has the overall shape of a C-shaped clip. In each assembly, the magnet 16 is placed between the first pole piece 12 and the second pole piece 14 so that the first pole piece 12 is on the same side as the north pole of the magnet 16 and the second pole piece 14 is on the same side as the south pole of the magnet 16. FIG. 4 is a perspective view of four assemblies like the two assemblies shown in elevation in FIGS. 1 and 2 and shows on example of the shapes that the pole pieces may assume and of the arrangement thereof around a ball-joint 4.

In the embodiment of FIGS. 1 to 3 four air gaps are produced between, on the one hand, the ball-joint 4 and to be more precise a portion of given polarity of the ball-joint 4, i.e. the half-sphere 8 or the half-sphere 10 in the embodiment shown, and, on the other hand, each of the pole pieces. There exists a magnetic field in each of these air gaps such that it tends to move the ball-joint away from the corresponding pole piece. To be able to vary the magnetic fields in the air gaps, and thereby to act on the ball-joint 4 (with no external action, an equilibrium position would be established), there is associated with each pole piece an induction coil 18 that partially surrounds the corresponding pole piece. Note that in FIGS. 1 and 2, in the same assembly (formed of a first pole piece 12, a magnet 16 and a second pole piece 14), the induction coils 18 disposed around the first pole piece 12 and around the second pole piece 14 are connected so that the same current flows in the two coils 18 of the same assembly. Depending on the direction of the current flowing in the coils 18 of an assembly, a magnetic field is added to or subtracted from the magnetic field corresponding to the polarization magnetic field of the corresponding magnet 16.

FIG. 1 shows the ball-joint 4 in an equilibrium position, the joystick 2 then being located in a position referred to as the neutral position. It is assumed that in this position all the air gaps (between each of the two parts of the ball-joint 4, i.e. here the half-sphere 8 and the half-sphere 10, and each of the pole pieces) is the same. It is further assumed that the shape of the surfaces of the pole pieces facing the ball-joint 4 matches the spherical exterior shape of each of the half-spheres so that the air gap between the half-sphere and the pole piece is of substantially constant thickness.

For its part, FIG. 2 shows the joystick 2 in a position pivoted relative to the equilibrium position of FIG. 1. This position can be reached either following an action of a user on the joystick 2 or following a modification of the magnetic fields around the ball-joint 4. Note that here the air gaps defined in the previous paragraph have changed. In fact, each pole piece has facing the ball-joint 4 a spherical shape but the four spherical surfaces belong to two separate spheres. Moreover, the rotation axis of the ball-joint does not correspond to a principal axis (or axis of revolution) of these two spheres. The air gaps between the half-spheres of the ball-joint 4 and the pole pieces are therefore modified.

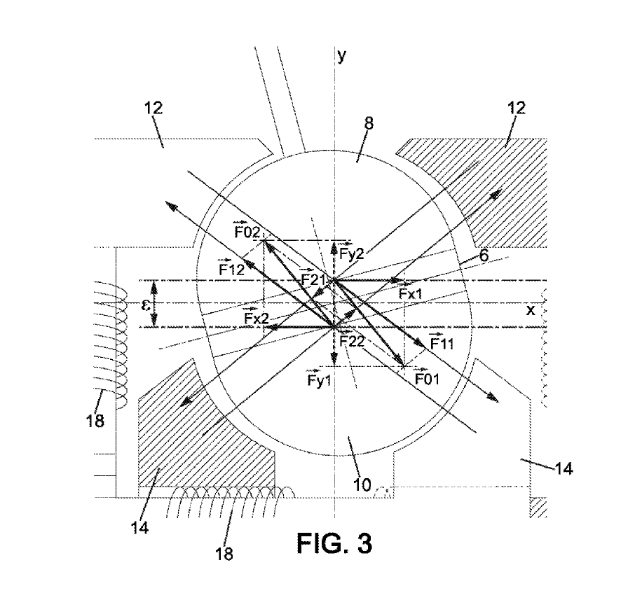

FIG. 3 shows forces exerted on the ball-joint 4 produced by the magnetic fields surrounding it when the ball-joint 4 is located in the position shown in FIG. 2. In this FIG. 3 there is firstly shown a system of axes with an abscissa axis (x) and an ordinate axis (y). It may be assumed that the abscissa axis is horizontal whereas the ordinate axis is assumed to be vertical. This orientation is chosen here for the purposes of the description but any other orientation could equally well be chosen.

Also shown in FIG. 3 is a force F̅11 that corresponds to the force exerted by a first assembly on the first half-sphere 8. Similarly, forces F̅12, F̅21 and F̅22 respectively correspond to the action exerted by the first assembly on the second half-sphere 10, the action exerted by the second assembly on the first half-sphere 8 and the action exerted by the second assembly on the second half-sphere 10. In the chosen embodiment shown in FIG. 3, these forces are assumed to be exerted at the center of the junction surface between the half-sphere concerned and the magnet 6.

The resultant force F̅01 (= F̅11+ F̅21) exerted on the first half-sphere 8 has components F̅x1 and F̅y1 on the abscissa axis and the ordinate axis, respectively. Similarly, F̅02 (= F̅12+ F̅22) exerted on the second half-sphere 10 has components F̅x2 and F̅y2 on the abscissa axis and the ordinate axis, respectively.

In the figure ε denotes the thickness of the magnet 6. Here this thickness also corresponds to the distance separating the points of application of the forces F̅01 and F̅02. The forces along the abscissa axis then produce a feedback torque

$$C = \frac{( \overline{F} x 1 + \overline{F} x 2 )}{2 ɛ} .$$

Note that, in the equilibrium position shown in FIG. 1, the ball-joint 4 is in a position such that the points of application of the forces F̅01 and F̅02 are on the ordinate axis. The resultant forces are moreover aligned on the ordinate axis. Because of this, there is no resultant torque. On the other hand, the tilting of the ball-joint or the modification of the magnetic fields in the pole pieces as a result of applying currents in the induction coils modifies the ratio of the amplitudes of the applied forces, thereby producing a feedback torque.

Note that, in this proposed embodiment, when the joystick 2 is in the rest position, its axis is an axis of symmetry of the system described hereinabove. Whatever the inclination of the ball-joint 4 and the amplitude of the magnetic fields (polarization fields and fields induced by the coils), there always exists a position in which the forces at the points of application defined above are parallel and of the same amplitude given the possible variations of the air gaps. In this position of ball-joint 4 is then in stable equilibrium from the point of view of movements in translation along the axis x or y independently of the currents in the coils and independently of the feedback torque induced if the forces are not collinear.

FIG. 4 shows an embodiment of the invention in which the joystick 2 is mobile in rotation about two articulation axes. This embodiment includes the elements shown in FIGS. 1 and 2 to which are added a third assembly and a fourth assembly similar to the first assembly and the second assembly. The third assembly is arranged relative to the fourth assembly in the same way that the first assembly is arranged relative to the second assembly. The third assembly and the fourth assembly are then disposed around the ball-joint 4 and offset 90° relative to the first assembly and the second assembly.

As explained with reference to FIGS. 1 to 3, this yields a system making it possible to generate force feedback by controlling the currents flowing in the induction coils when the joystick 2 pivots about two articulation axes for all the positions that said joystick can assume within a given angular range.

In this embodiment (FIG. 4) there are therefore third pole pieces 20 and fourth pole pieces 22. Each of the third and fourth assemblies includes a third pole piece 20 and a fourth pole piece 22 separated by a magnet 16 the north pole of which is against the third pole piece 20 and the south pole of which is against the first pole piece 22.

When the side-stick in accordance with the invention is intended to be used in the aeronautical field, severe safety standard apply and in particular there is provision for electrical systems to include redundancy. It is easy in the case of the present invention to produce a redundant circuit. Duplicating all the magnetic circuits may be envisaged. However, given the intrinsic safety of the pole pieces themselves, only redundancy at the level of the induction coils is necessary. FIG. 5 shows a side-stick in which the coils 18 have been duplicated so as to produce a redundant system.

FIG. 6 shows a variant embodiment of the present invention that is simplified relative to the FIG. 4 embodiment.

For the description of the variant embodiments of FIGS. 6 to 8, the references used in FIGS. 1 to 5 are used again to designate similar elements even if they are of different shape.

In the FIG. 6 variant, there is an articulation part referred to hereinafter as the ball-joint 4 fixed to a joy stick 2. The ball-joint 4 includes a central magnet 6 having the shape of a half-disk and disposed between a first part 8 of quarter-sphere shape and a second part 10 also of quarter-sphere shape. Compared to the previous embodiments, the orientation of the joystick 2 relative to the magnet 6 is different. Whereas in the previous embodiments the joystick 2 was perpendicular to the magnet 6, in FIG. 6 it is in the plane of the magnet 6. Moreover, to create a feedback force on the ball-joint 4 a mechanical ball-joint 5 (and its corresponding bearing, not shown) is also provided, for example.

Whereas in the FIG. 4 embodiment there were in total 8 pole pieces, the FIG. 6 embodiment provides four pole pieces, a first pole piece 12 facing (only) the first part 8, a second pole piece 14 facing (only) the first part 10, a third pole piece 20 facing (only) the first part 8, a fourth pole piece 22 facing (only) the first part 10. Each pole piece is associated with an induction coil 18 to enable modification of the magnetic field in the air gap between each pole piece and the ball-joint 4. The first pole piece 12 and the second pole piece 14 can act on the ball-joint 4 by causing a current to flow in the corresponding induction coils 18 so as to exert a resisting torque on the ball-joint 4 or to move the joystick 2 with no action on the part of a user (in a fixed-wing aircraft, for example, when a side-stick is duplicated, it is known to cause the second side-stick to move into the position that a user imparts to the first side-stick). Similarly, in another plane, perpendicular to the plane of action of the first pole piece 12 and the second pole piece 14, the third pole piece 20 and the fourth pole piece 22 can act on the ball-joint 4 by causing an appropriate current to flow in the corresponding induction coils 18.

Here the pole pieces are also polarized by a magnet 16 (and by the coils 18). Assemblies are also formed with a magnet 16 sandwiched between two pole pieces. However, whereas in the FIG. 4 embodiment such an assembly related to two pole pieces acting in the same plane, here one pole piece of the assembly relates to action in one plane and the other relates to action in the perpendicular plane. An assembly is therefore formed with a magnet 16, the first pole piece 12 and the fourth pole piece 22 and another assembly is formed around another magnet 16 with the second pole piece 14 and the third pole piece 20 (and of course, with each pole piece, in each of the assemblies, there is also at least one induction coil 18). The person skilled in the art will immediately notice that in this case it is no longer a question of connecting together the coils 18 of the same assembly.

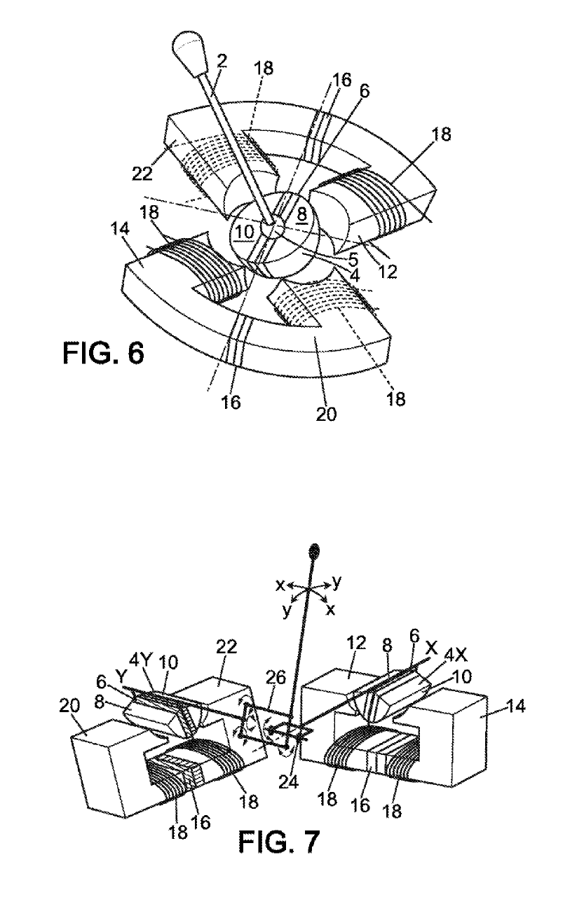

The embodiment shown in FIG. 7 entirely decouples the action exerted by the system on the joystick 2 about a first articulation axis of the joystick 2 from the action exerted on the latter about a second articulation axis. Furthermore, the joystick 2 is not fixed relative to a ball-joint, but rather a transmission mechanism is provided between the joystick 2 and the elements assembled as magnetic bearings.

Firstly, in this embodiment, the joystick 2 is articulated by means of a system obtained by combining a universal joint 24 and a pantograph 26 so that when the joystick 2 pivots in a direction x it drives in rotation a shaft X and when the joystick 2 pivots in a direction y it drives in rotation a shaft Y. In the embodiment shown in FIG. 7, the shaft X carries at one of its ends the universal joint 24 whereas the pantograph 26 drives in rotation the shaft Y.

Each of the shafts X and Y carries a part including a first magnetic material portion 8 polarized with a first magnetic polarity and a second magnetic material portion 10 polarized with a magnetic polarity opposite the first magnetic polarity. As in the entirety of the present document, this part is also referred to here as a “ball-joint”. To distinguish the two ball-joints, the ball-joint carried by the shaft X bears the reference 4X whereas the other ball-joint, carried by the shaft Y, bears the reference 4Y. Each ball-joint is rigidly attached to the shaft that bears it. FIG. 7 proposes to conform each ball-joint as part of a circular cylinder having in a median position a magnet 6 on respective opposite sides of which is a first magnetic material portion 8 and a second magnetic material portion 10. The person skilled in the art will understand that here this is one shape chosen from numerous others. To avoid a large imbalance on the shaft X and the shaft Y, there could therefore be ball-joint 4X and a ball-joint 4Y better distributed around its pivot axis, the shaft 4X or 4Y corresponding for example to a longitudinal shaft passing through the center of gravity of the corresponding ball-joint. A substantially spherical or hemispherical shape may equally well be envisaged here. The presence of the imbalance is mechanically beneficial here, however, because it makes it possible to add an additional force (gravity) to act upon the joystick 2 and create a return force. The ball-joints 4X and 4Y are in fact positioned on the shaft X and the shaft Y so that their stable equilibrium position corresponds to the “rest” position of the joystick 2. Note here that the mechanical system between the ball-joints 4X and 4Y could be different from the system shown in FIG. 7. It is however important that on the one hand the joystick 2 can drive in rotation the shafts X and Y and on the other hand action on the shafts X and Y can be transmitted to the joystick. The transmission system between the ball-joints and the joystick must therefore be reversible.

The ball-joint 4X is placed between two pole pieces: a first pole piece 12 facing the first portion 8 (only) of the ball-joint 4X and a second pole piece 14 facing (only) the second portion 10 of the ball-joint 4X. Similarly, the ball-joint 4Y is placed between two pole pieces: a third pole piece 20 facing (only) the first portion 8 of the ball-joint 4Y and a fourth pole piece 22 facing (only) the second portion 10 of the ball-joint 4Y. With each pole piece are associated, on the one hand, a magnet 16 polarizing it and, on the other hand, an induction coil 18. The end of the pole pieces facing the corresponding ball-joint is also conformed here so that the air gap is substantially constant over the entirety of the facing surface in the rest position, this air gap varying when the corresponding ball-joint pivots about its axis. Each time the pole pieces face a portion of the corresponding ball-joint of the same magnetic polarity so as to create a repulsion force that increases as the air gap decreases. Here a stable equilibrium position is also reached when all the air gaps are equal (for magnetic fields of equal amplitude).

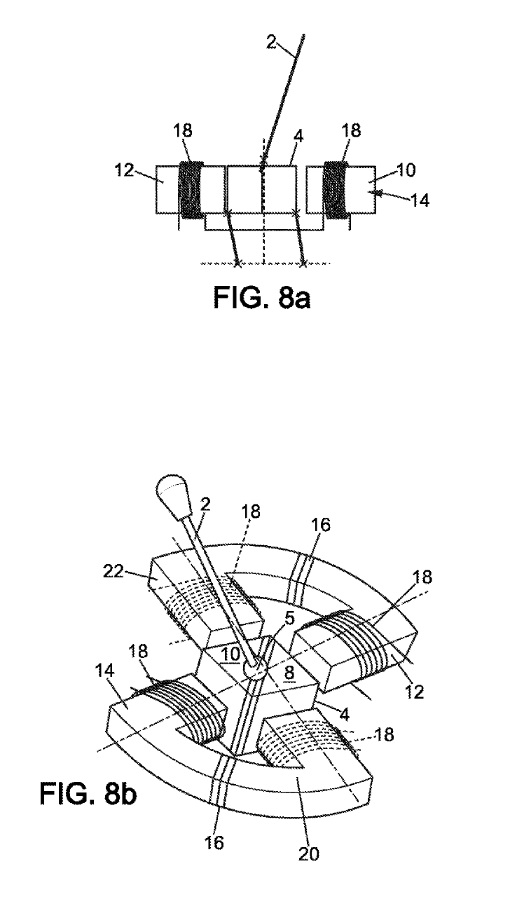

A fifth embodiment is shown in FIGS. 8a and 8b. This is fact a variant embodiment of third embodiment from FIG. 6. In this embodiment, the ball-joint 4 is of cubic (or parallelepiped) shape. By means of appropriate articulations, one (lower) face of the cubic ball-joint 4 remains parallel to a (for example horizontal) reference plane. The ball-joint 4 then moves between the four pole pieces of the system, the equilibrium position being reached when the corresponding four gaps are equal.

The system described is of course associated with electronic command and control means. Position sensors are provided so that the position of the joystick 2 is known. As a function of this position, and possibly of other internal or even external parameters of the side-stick, a feedback force is determined by a computer, for example a microcontroller. Once this feedback force has been determined, the intensity of the force (in Newtons or Newton-meters) is converted into an electrical current (in Amperes) to define the characteristics of the electrical currents that have to be made to flow in each induction coil in order to obtain the required force feedback.

These various elements (position sensors or movement sensors, possibly force sensor and/or joystick speed of movement sensor, computer, control system for the currents flowing in the coils, etc.) are not shown in the drawings.

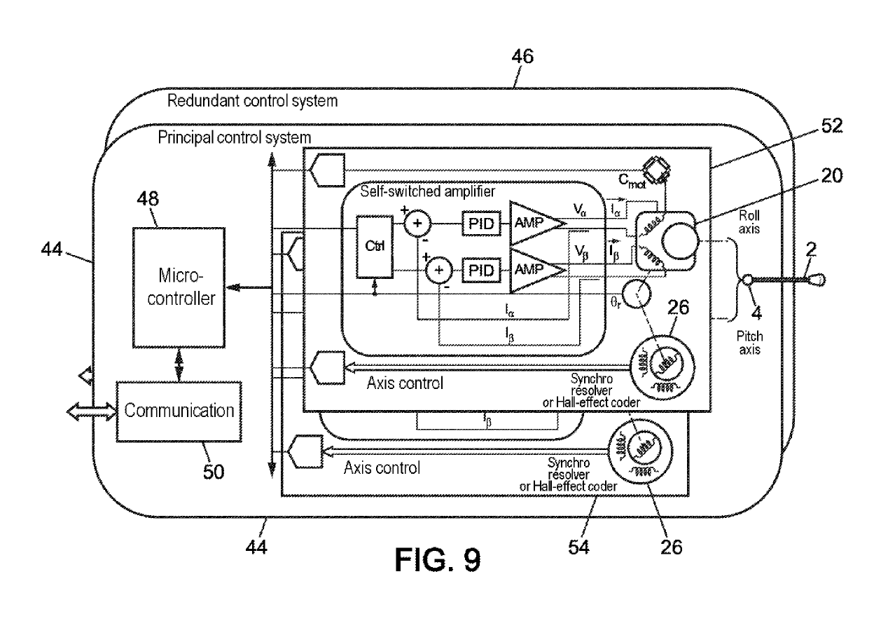

In FIG. 9 is shown a principal control system 44 and a redundant control system 46. These two systems are similar and have the same structure. Each may be assembled to form an assembly, and the two assemblies obtained can be superposed as shown in FIG. 9 in which there are therefore seen only the elements of the principal control system 44.

The principal control system 44 includes a microcontroller 48 associated with an interface 50 for communication with other electronic systems. If the joystick 2 is intended to control the inclination of an aircraft (fixed-wing aircraft or helicopter) about its roll axis and its pitch axis, there are for example provided a first assembly 52 for the control of the system on the roll axis and a second assembly 54, substantially similar to the first assembly 52, for the control of the system on the pitch axis.

FIG. 9 also shows again various elements of a side-stick in accordance with the invention to illustrate better the functions of the control system.

As emerges from the foregoing description the present invention makes it possible to produce a side-stick that can be used to control an aircraft, for example a fixed-wing aircraft or a helicopter. This side-stick can notable be used as a roll and pitch control member of the aircraft. Force feedback is integrated into the structure of the side-stick. The forces produced result from the opposition of magnetic fields created between fixed pole pieces and a mobile part connected to a side-stick joystick. Air gaps are created between the fixed pole pieces and the mobile part. An equilibrium situation, for example corresponding to a rest position, is obtained when all the air gaps are identical.

The force feedback rule is applied by controlling the electrical currents flowing in induction coils. It is therefore possible to achieve rapid and accurate control of the forces exerted on the joystick of the side-stick. The feedback forces (or torques) can be adjusted by calculation knowing the position of the joystick to be controlled and/or by adding force sensors to slave the feedback forces (torques).

The ball-joints described above may be supported only by the magnetic bearings described (notably as shown in FIG. 4) but may also necessitate mechanical guidance of the ball-joint. Guidance of this type or of some other type suited to the situation (shape of the ball-joint and environment) may be provided for the other embodiments.

The present invention is not limited to the embodiments described hereinabove by way of nonlimiting example and the variants mentioned. It concerns equally all variant embodiments within the scope of the following claims evident to the person skilled in the art.

1. A side-stick with force feedback including a joystick (2) having a degree of freedom in rotation about a first articulation axis, comprising:
a first articulation part (4) including a first portion (8) having a first magnetic polarity and a second portion (10) having a second magnetic polarity opposite the first magnetic polarity,
reversible movement transmission means between the first articulation part (4) and the joystick (2) connecting the first articulation part (4) to said joystick (2) so that a movement of rotation of the joystick (2) about the first articulation axis is transmitted to the first articulation part (4) which can additionally and conversely drive the joystick (2) in rotation about its first articulation axis,
at least one first pole piece (12) substantially facing the first portion (8) of the first articulation part (4),
at least one other, second pole piece (14) substantially facing the second portion (10) of the first articulation part (4),
first polarization means (18) for acting on the first pole piece (12) to polarize the first pole piece (12) with the first magnetic polarity,
second polarization means (18) for acting on the second pole piece (14) to polarize the second piece (14) with the second magnetic polarity,
means supplying measurement signals representing the position and/or the movement of the joystick (2) or of the articulation part (4), and
control means acting on the first polarization means (18) and on the second polarization means (18) in such a manner as to vary the magnetic field created by the first polarization means (18) and the magnetic field created by the second polarization means (18) as a function of the position and/or movement measurement signals.

2. The side-stick as claimed in claim 1, wherein the joystick (2) has a second degree of freedom about a second articulation axis and the side-stick further comprises:
a second articulation part (4) including a third portion (8) having a first magnetic polarity and a fourth portion (10) having a second magnetic polarity opposite the first magnetic polarity,
reversible movement transmission means (24, 26) between the second articulation part (4) and the joystick (2) connecting the second articulation part (4) to said joystick (2) so that a movement of rotation the joystick (2) about the second articulation axis is transmitted to the second articulation part (4) which can additionally and conversely drive the joystick (2) in rotation about its second articulation axis,
at least one third pole piece (20) substantially facing the third portion (8) of the second articulation part (4),
at least one other, fourth pole piece (22) substantially facing the fourth portion (10) of the second articulation part (4),
third polarization means (18) for acting on the third pole piece (20) to polarize the third pole piece (20) with the first magnetic polarity, and
fourth polarization means (18) for acting on the fourth pole piece (22) to polarize the fourth pole piece (22) with the second magnetic polarity.

3. A side-stick with force feedback including a joystick (2) having a first degree of freedom in rotation about a first articulation axis and a second degree of freedom in rotation about a second articulation axis, comprising;
an articulation part (4) including a first portion (8) having a first magnetic polarity and a second portion (10) having a second magnetic polarity opposite the first magnetic polarity,
reversible movement transmission means between the first articulation part (4) and the joystick (2) connecting said articulation part (4) to said joystick (2) so that a movement of rotation of the joystick (2) about the first articulation axis and about the second articulation axis is transmitted to the articulation part (4) which can additionally and conversely drive the joystick (2) in rotation about the first articulation axis and about the second articulation axis,
at least a first pole piece (12) and a third pole piece (20) substantially facing the first portion (8) of the articulation part,
at least a second pole piece (14) and a fourth pole piece (22) substantially facing the second portion (10) of the articulation part,
first polarization means (18) for acting on the first and third pole pieces to polarize the first and third pole pieces with the first magnetic polarity,
second polarization means (18) for acting on the second and fourth pole pieces to polarize the second and fourth pole pieces with the second magnetic polarity,
means supplying measurement signals representing the position and/or the movement of the joystick or of the articulation part, and
control means acting on the first polarization means and on the second polarization means in such as manner as to vary the magnetic field created by the first polarization means and the magnetic field created by the second polarization means as a function of the position and/or movement measurement signals.

4. The side-stick as claimed in claim 1, wherein an articulation part (4) includes a central magnet (6) between two parts made from a magnetic material so that one part is polarized by the magnet (6) with a first magnetic polarity and the other part is polarized by the magnet with a magnetic polarity opposite the first magnetic polarity.

5. The side-stick as claimed in claim 1, wherein the polarization means include a coil (18) disposed around a magnetic material core and means for supply the coil with electrical current.

6. The side-stick as claimed in claim 1, wherein each pole piece is polarized by a magnet (16).

7. The side-stick as claimed in claim 1, wherein each pole piece facing an articulation part portion has a surface facing the articulation part such that on rotation of the articulation part about an articulation axis the distance between a given point of said surface and the articulation part varies.

8. The side-stick as claimed in claim 2, wherein an articulation part (4) includes a central magnet (6) between two parts made from a magnetic material so that one part is polarized by the magnet (6) with a first magnetic polarity and the other part is polarized by the magnet with a magnetic polarity opposite the first magnetic polarity.

9. The side-stick as claimed in claim 2, wherein the polarization means include a coil (18) disposed around a magnetic material core and means for supply the coil with electrical current.

10. The side-stick as claimed in claim 2, wherein each pole piece is polarized by a magnet (16).

11. The side-stick as claimed in claim 2, wherein each pole piece facing an articulation part portion has a surface facing the articulation part such that on rotation of the articulation part about an articulation axis the distance between a given point of said surface and the articulation part varies.

12. The side-stick as claimed in claim 3, wherein an articulation part (4) includes a central magnet (6) between two parts made from a magnetic material so that one part is polarized by the magnet (6) with a first magnetic polarity and the other part is polarized by the magnet with a magnetic polarity opposite the first magnetic polarity.

13. The side-stick as claimed in claim 3, wherein the polarization means include a coil (18) disposed around a magnetic material core and means for supply the coil with electrical current.

14. The side-stick as claimed in claim 3, wherein each pole piece is polarized by a magnet (16).

15. The side-stick as claimed in claim 3, wherein each pole piece facing an articulation part portion has a surface facing the articulation part such that on rotation of the articulation part about an articulation axis the distance between a given point of said surface and the articulation part varies.
